(19) United States
(12) Patent Application Publication
(10) Pub. No.: US 2010/0123262 A1
(43) Pub. Date: May 20, 2010

(54) MULTI-ORIFICE EXTRUSION DIE AND METHOD FOR OBTAINING UNIFORM FLOW

(76) Inventors: Lewis Conrad Keller, McKinney, TX (US); Donald Joe Tatsch, Tioga, TX (US)

Correspondence Address: CARSTENS & CAHOON, LLP, P O BOX 802334, DALLAS, TX, 75380, US

(21) Appl. No.: 12/273,355

(22) Filed: Nov. 18, 2008

(51) Int. Cl. B29C 47/92

(52) U.S. Cl. 264/40.7; 425/114

(57) ABSTRACT

A method for normalizing the exit velocity of multiple extrudate strands from a multiple die extruder and apparatus for producing the same. The invention describes utilizing a die with individual channels, and installing metering assembly on each individual channel. The metering assembly can then be adjusted to independently increase or decrease the velocity of product through an orifice. By independently adjusting individual velocities of extrudate strands, after successive iterations of adjusting, measuring, and readjusting, a plurality of extrudate stands can be produced having substantially uniform velocity. Further the invention can comprise a single extruder or a co-extruder used to make a co-extruded product wherein uniform velocity becomes more desirable.

### BACKGROUND OF THE INVENTION

1. Technical Field

The present invention relates to an extrusion die for extruding material through a plurality of die orifices. It especially relates to an extrusion die which produces a plurality of extrudate strands of substantially uniform velocity.

2. Description of Related Art

Extrusion of products of various profile shapes is usually accomplished by extruding through, for example, wide orifices to produce a sheet of extrudate or as another example, through an annular orifice to produce a tubular extrudate. As used herein a channel is a pipe-like feature or conduit through which product can flow, which is located within an extruder die, and which is in fluid communication with an associated orifice. Extrusion dies having multiple extrusion orifices and radial placement are widely used to make direct expanded products to achieve industrial production rates. While radial placement provides a geometrically identical flow path through the channels to each orifice, the radial symmetry of the orifice position does not result in equal flow from each orifice. This is due in part to the fact that the dough usually has laminar flow characteristics, which prevents pressure and velocity differences originating at the screw discharge area from equalizing by mixing since there is no turbulent flow. The lack of equal flow from each orifice becomes a difficult problem when, for example, multiple extrudate strands enter crimped cutter rollers. If the flow from each orifice differs then some strands will be pulled taut, possibly breaking the strand, whereas other strands will be slack, causing them to accumulate before being crimped to the extent that they may interfere with adjacent strands or fold over upon themselves. This problem is exaggerated when the size of each strand needs to be more uniform for a given product. One such product class is co-extruded products wherein one food product is inside and surrounded by another extruded food product. Because one product is being fed into the inside of another food product, the extrusion velocities of each product are more critical than in other applications. The outer extruder product velocity has to be almost identical to the velocity of the inside product.

There have been many attempts to produce extrudate of uniform velocity, each with varying flaws and limitations. One example of such an attempt is U.S. Pat. No. 4,088,433 to Simpson. Simpson notes that, due to the laminar characteristics of the fluid, the velocity of the product extruded through the center orifices was greater than the velocity at the peripheral of the die despite the die providing a geometrically identical path. This is due partially to the fact that the die used in Simpson had the same diameter as the auger, which resulted in a parabolic velocity profile. To attempt to overcome this problem Simpson discloses increasing the resistance encountered by the fluid flowing in the center by decreasing the density of orifices at the center of the die. Simultaneously, Simpson discloses decreasing the resistance encountered by the fluid flowing at the periphery by increasing the density of orifices at the periphery of the die. However, this method has the disadvantage that it achieves balanced flow only for a narrow range of operating conditions. If for example, operating parameters such as flow rate, or raw material attributes are altered, the viscosity will change, and the laminar flow characteristics will change accordingly. Thus, the requisite orifice density will need to be changed requiring a new die face. Because the die face is not adjustable, fine tuning during production is impossible. While the referenced prior art may succeed in slightly altering the parabolic flow, the prior art cannot be line tuned to result in approximately uniform velocities. Additionally, because orifices are placed all around the die face, not just along the periphery, co-extruding in the center of the die face will be difficult.

Another example of prior art attempting to produce extrudate of uniform size and velocity is described by Paul Richardson in his book Introduction to Extrusion. Paul Richardson, Introduction to Extrusion, Society of Plastics Engineers (1974). Mr. Richardson teaches of an extruder die which comprises a large manifold attached to a wide path through which product is extruded. As the extruder die comprises a wide path, sheets of extrudate comprising a corresponding width are produced rather than tubular extrudate. The manifold's shape, referred to as “linear” or “flat” distributes the product. The thickness and velocity of the sheet can be controlled by using multiple choker bars. Each choker bar “chokes” the fluid flowing from the manifold and acts as a dam. Because such dies comprise large manifolds, the dough typically has high residence times within the die which may be undesirable for some dough formulations. In some embodiments of this prior art, mean residence time as high as forty-five seconds or greater has been achieved. As used herein, residence time is the time which product spends in the extruder die. It is well known in the art that the extrusion process is highly dependent on temperature, time, as well as other factors. Product being exposed to longer residence limes and greater temperatures may cause product degradation in some product dough formulations. For example, many products may cure or gel if exposed at certain temperatures for too long of time. Such curing or gelling is typically avoided as it can plug the equipment and produce undesirable product. Furthermore, the choker bar method typically requires special expertise to design seals which prevent the extrudate from leaking between the moveable parts of the adjusting mechanism which can significantly increase the cost of the die.

It should be noted that professional die designers can use computational fluid dynamics (CFD), a branch of fluid mechanics that uses numerical methods, to analyze and design a die with approximately balanced flow. However, the use of CFD requires significant and costly expertise to set up the computational grid to model die designs, and further expense for computing resources. A further expense is the risk of error in computed results in case error exists in the assumed flow behavior properties of the food material. This is because food extrudate materials are fairly intractable with respect to measuring flow behavior because food biopolmers' flow behavior is greatly affected by moisture content, which is not a problem with dry synthetic polymers, and because food composition is much more heterogenous compared to synthetic polymers. The ultimate cost of die design may therefore be judged prohibitive considering the risks.

For the reasons stated above, it is desirable to have an extruder die which can produce a product which comprises a substantially uniform flow velocity. Likewise, it is desirable to produce a plurality of extrudate strands, not sheets, which have a substantially uniform velocity. Further, it is desirable to have an extruder die that can handle dough wherein low residence times may be necessary. Additionally, it is desirable to find a method and extruder die which results in a substantially uniform flow velocity that can be used in extrusion or co-extrusion. Finally, it is desirable that said method be faster and less expensive than prior art methods.

### SUMMARY OF THE INVENTION

The current invention discloses a method and apparatus which can be used to produce a plurality of extrudate strands from an extruder which have uniform velocity. The invention uses an extruder system having multiple channels in the die and discloses installing adjustable metering assembly on each channel of the extruder die. Product is then fed through the extruder die and its velocity is measured. The metering assembly at each channel can be adjusted to increase or decrease the flow and velocity through each channel individually. Adjustments are made only when the die is not in operation so that it can be used for hot extrudate subject to curing and gelling. Product is once again introduced into the extruder system and is subsequently measured. Adjustments can then again be made to the metering assemblies. After subsequent iterations each channel can be metered so that each die will exhibit a more uniform velocity. Thus, extrudate strands of uniform velocity can be extruded for a given product at defined operating conditions. Finally, because strands of uniform velocity can be produced, the current invention can be utilized in multi-extrusion processes where it is more desirable that each product have a uniform velocity.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a planar view of a multi-orifice co-extrusion die face used in conjunction with one embodiment of the invention.

FIG. 2 is a top cut away view of a twin-screw extruder and a multi-orifice co-extrusion die.

FIG. 2A is a close up view of one channel of the co-extrusion die of FIG. 2.

FIG. 3 is a graph charting velocity of extrudes from a radially placed multi-orifice die.

FIG. 4A is a cross sectional flow profile of a D-shaped channel.

FIG. 4B is a cross sectional flow profile of a D-shaped channel which has been partially closed.

### DETAILED DESCRIPTION

Several embodiments of Applicants' invention will now be described with reference to the drawings. Unless otherwise noted, like elements will be identified by identical numbers throughout all figures.

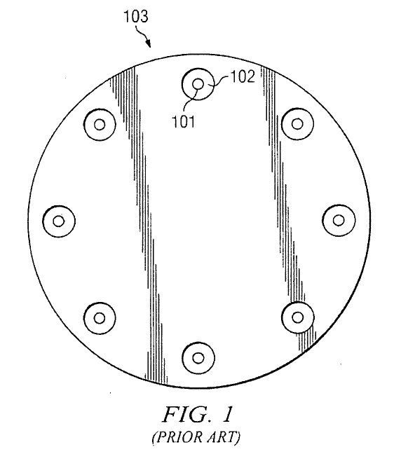

FIG. 1 shows a planar view of a prior art co-extrusion die face, that can be used with one embodiment of the current invention wherein the co-extrusion die orifices are radially placed around the die face 103. Looking at FIG. 1 it can be seen that each co-extrusion orifice consists of two concentric appertures, an inner round orifice 101 and outer annular orifice 102. The inner orifice 101 represents the orifice where the inner product is introduced to the co-filled product, typically from a separate source. The outer concentric orifice 102 is the orifice where the outer extruded product exits the die face 103. Note that while FIG. 1 is a depiction of a co-extrusion die, the instant invention is not so limited. The instant invention provides a novel apparatus and method of producing a uniform velocity of extrudate from a plurality of channels. This invention can be applied to both single extrusion processes as well as co-extrusion processes resulting in extrudate strands of uniform velocity. As used herein extrudate strands refers to any product which has been forced through and shaped by an orifice resulting in a tubular or thread-like shape. “Uniform velocity” or “substantially uniform velocity,” as used herein means velocity strands which have a velocity variance of less than about 10% of the mean velocity, more preferably less than about 5% of the mean velocity, and most preferably less than about 1% of the mean velocity. Variance as used herein is the percent difference of a data point as measured against the mean for the entire data set.

Co-extrusion, as used herein, is the process of making a co-filled product wherein the center of the product comprises a first food product and the outer portion of the product comprises a second food product, and at least one of the products is extruded. Thus, in co-extrusion the two products typically come from two independent sources. For example, in one embodiment the outer portion is a direct-expanded extrudate. A direct-expanded product is one which puffs immediately after extrusion due to the conditions of the extruder and the properties of the product. In one preferred embodiment, the second food product comprises an extruded food product. The extrudate is formed around a die resulting in a hollow product which can be filled with another food product. The other food product may either be extruded from a second extruder or simply pumped. It should be noted that it is also possible to produce a co-filled product wherein the inner product is extrusion cooked and the outer product is not. Thus, in a co-filled product either the inner or the outer product, or both can be extrusion-cooked food product. As used herein, extrusion cooked refers to product which has been extruded at temperatures sufficient to produce substantial water vapor pressure resulting in product expansion.

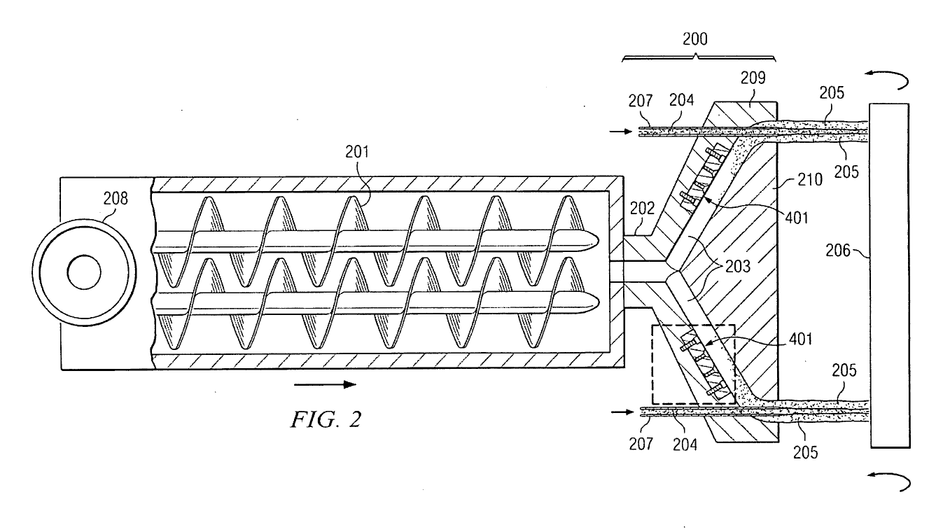

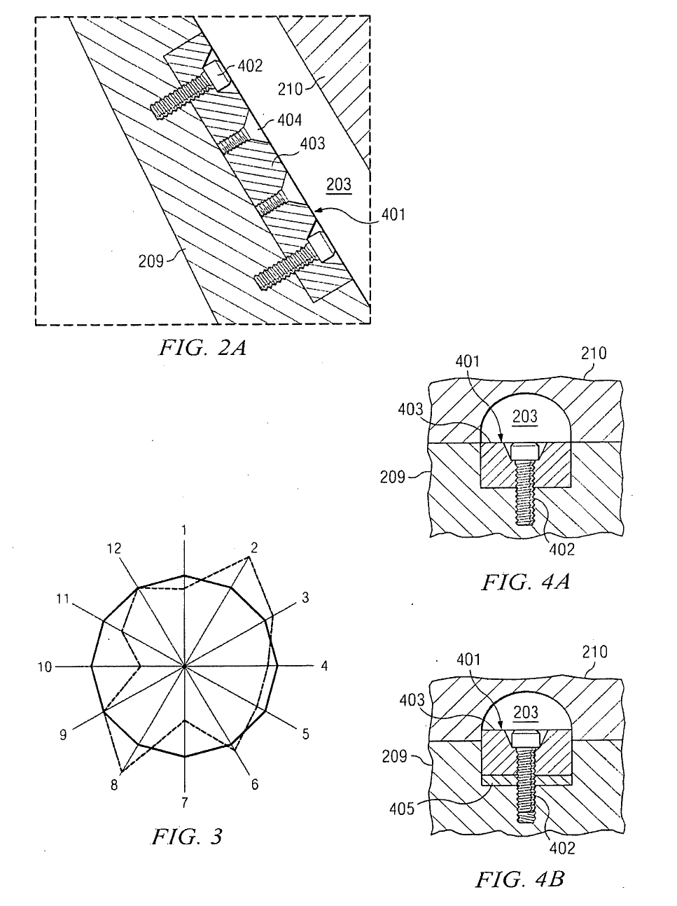

FIG. 2 is a top cut away view of a twin-screw extruder and a multi-orifice co-extrusion die. It should be noted that as used herein “extruder” refers to equipment which produces extrudate and includes a conveying means such as an auger or augers. The term “extruder die” refers to the die attached to an extruder through which extrudate is extruded. Finally, the term “extruder system” includes the extruder as well as the extruder die. Thus, in the embodiment depicted by FIG. 2, the term extruder system includes the screw augers 201 as well as the extruder die 200. In many embodiments a die plate (not shown) comprising nozzles will be attached to the exit end of the die 200. Those skilled in the art will understand the use and design of a die plate.

Product is introduced into the feeder 208 wherein it is acted upon by co-acting screw augers 201 in what is referred to as a twin-screw extruder. It should be noted that while this embodiment depicts screw augers 201 the current invention is not so limited. Any known means of mixing, shearing, and directing a product to a location may be used. Extruders using screw augers 201 can generate a significant amount of heat due to dissipation of mechanical energy; many of such extruders optionally have either heating or cooling jackets (not shown) or both to provide or remove heat from the process. As described above, extrusion is a very time and temperature dependent process. Therefore, it is important to control the extrudate temperature. It has been found in some embodiments that the heat generated by the co-acting screws 201 from the friction being exerted from both the food and the screw provides sufficient heat so that heat actually needs to be removed by cooling jackets. The flow rate through such a twin screw extruder is limited by the size and revolution of the auger or augers, the resistance to flow of the extruder die, and the drive power of the motor controlling the auger, but ranges, in one embodiment, from about 150 pounds per hour to about 7,000 pounds per hour. The exit velocities with which Applicants are concerned with are in the range of about 30 feet per minute to about 200 feet per minute. Applicants consider any extrusion above 30 feet per minute to be a “high velocity” extrusion process for which Applicants' invention is ideally suited.

As the product to be extruded is mixed, it is pushed along by the screw auger 201 until the product has reached the inlet 202 of the extruder die 200. The temperature of the product in the inlet 202 of the extruder die 200 ranges from about 150° F. to about 250° F., more preferably from about 180° F. to about 230° F. for a pellet product. For a direct-expanded product the temperature ranges from about 250° F. to about 450° F., and more preferably from about 325° F. to about 425° F. The temperatures are typically measured by a thermocouple or the like located at the inlet 202 of the extruder die 200. The pressure, also measured in the inlet 202, typically ranges from about 800 psig to about 2,500 psig, although the pressure can be much higher.

The product is then equally divided into a plurality of channels 203. As discussed above, these channels are individual narrow paths in the extrusion die 200 through which product can flow to associated orifices in the die face. Thus, each channel 203 is in fluid communication with an exit orifice with which it is associated. The size of the channel 203 can vary with the desired product size. The channels 203 can be of any size and shape, but are typically half-pipe or D-shaped and have cross sectional areas that allow reasonable shear rates and residence times at the operational flow rates. In one embodiment, a cross sectional area as small as about 0.05 square inches has been employed. As depicted, the channels 203 are milled into a male portion 210 of the extruder die 200. Thus, when the male 210 and female 209 portions of the die are not mated, the channel 203 is visible on the surface of the male portion 210. However, when the male 210 and the female 209 portions are mated, the channels 203 become enclosed. The male 210 and female 209 portions are connected by various means known in the art such as bolts to ensure that they are securely mated and do not leak. It should be noted that in other embodiments, the channels are grooved into the surface of a female portion 209 of the die. Other methods of making channels 203 such as casting the extrusion die 200 around a mold which comprises channels can also be utilized. FIG. 2 only depicts two channels 203 for clarity purposes. This number, however, should not be deemed limiting as the instant invention is successful on virtually any number of channels. Further, as described above, in one embodiment the channels are placed radially along the die face. Still further, in one embodiment is it preferred that the die face of the die 200 comprise a diameter wide enough to allow better handling of the extrudate in downstream operations.

Once extrudate has entered a channel 203 it is no longer in parallel communication with the extrudate in the other channels 203. The channels 203 of FIG. 2 are typically of equal length and volume. One would predict that because the channels 203 are of equal length and volume that the flow rate through each channel and their respective orifices would be the same. However, this is not typically the case.

FIG. 3 shows a graph charting the velocity of extrudates from a radially placed multi-orifice die with twelve identical die orifices, each associated with a corresponding channel, each of equal length, volume, and geometry. The solid line shows the mean velocity of extrudate exiting each of the orifices averaged for all twelve orifices. The dashed lines connect all the data points of the actual flow velocity of extrudate at each orifice. The numbers correspond to orifice positions. It can be seen that many orifices, particularly orifices 2 and 8 have greater velocities than the other orifices. Without being limited to theory it is believed that these variances are not caused by a parabolic flow as discussed above with regard to Simpson, but instead arise from a differential pressure profile at the exit of the co-rotating twin screw auger 201 (of FIG. 2). Many of the orifices directly next to orifices 2 and 8 have decreased velocities. Orifices 7 and 10 exhibit velocities well below the mean velocity. If every orifice has identical velocities, then the dashed line and the solid line will comprise the same line. Again, it is important to note that each of these orifices have channels leading to them that were of equal volume and length. Thus, while one would predict that each orifice should have a constant velocity, in practice this is not the case. Such a graph depicts one of the tools used by Applicants in this method of monitoring and adjusting the process to be discussed below.

It should be noted that although FIG. 3 and FIG. 2 depict dies comprising channels of equal volume, length, and geometry, the current invention is not so limited. As will be discussed more below, the current invention allows each channel to be adjusted independently, resulting in extrudate strands of uniform velocity. Consequently, although channels of non-uniform length and size may require more adjustments, the method of the current invention still results in extrudate strands of uniform velocity given that the differences in length and size are not too large.

Referring back to FIG. 2, as discussed above FIG. 2 shows a plurality of channels 203. Associated and in communication with each channel 203 is a metering assembly 401. FIG. 2A depicts an enlarged version of the area indicated by the dashed box in FIG. 2. Referring to FIG. 2A, the metering assembly 401 includes the collective assembly comprising a flow restrictor 403, a fastener device 402, and jack screws 404. It should be noted that as shown in FIG. 2A and FIG. 2, fluid will flow perpendicular to the width of the flow restrictor 403 but parallel to its length. Thus, in FIG. 2A, the length of the flow restrictor 403 is depicted. The width of the flow restrictor 403, the side which the fluid encounters, is depicted in FIGS. 4A and 4B which are addressed below.

FIG. 2A shows only one embodiment of the current invention; metering assembly 401 other than the one depicted may also be utilized in the current invention. The flow restrictor 403 can comprise a rectangular block, an annular plug, a threaded bolt, a screw, a peg, a washer, or any other means known in the art to resist flow and decrease flow rate. FIG. 2A shows a rectangular block used as the flow restrictor 403 and a threaded bolt used as the fastener device 402. Because each channel 203 has its own metering assembly 401, each channel's velocity can be adjusted independently. To adjust a channel's metering assembly 401, the extruder is first stopped. Then, depending on the configuration of the die 200, the selected metering assembly 401 is removed. The die depicted in FIG. 2A, as discussed above, comprises a male portion 210 and a female portion 209. Thus, in the die depicted in FIG. 2A, the male 210 and female 209 portions are separated from one another, revealing the metering assembly 401.

As discussed above, the metering assembly 401 depicted in FIG. 2A comprises fastener devices 402, a flow restrictor 403, as well as jack screws 404. The fastener devices 402 are used to secure the flow restrictor 403 to the die 200. The jack screws 404 are useful when removing the flow restrictor 403 such as for the installation or removal of a shim 205 (not shown in FIG. 2A). Often, after producing extrudate, material plugs and sticks to the metering assembly 401. Accordingly, it is sometimes difficult to remove and adjust the metering assembly 401. To overcome this, in one embodiment the metering assembly 401 comprises jack screws 404 which can be used to separate the flow restrictor 403 from the die 200. As the jack screws 404 are rotated they abut against the die and push out against the flow restrictor 403 so that the metering assembly 401 can be removed. It should be noted that these jack screws 404 are optional. Once the metering assembly 401 is removed, shims (not shown in FIG. 2A) are inserted to the die 200.

The shim 405 can be better discussed in reference to FIGS. 4A and 4B. FIGS. 4A and 4B show two half-pipe or D-shaped channels 203. FIG. 4A shows a D-shaped channel 203 wherein the metering assembly 401 is completely open. This allows product to flow through the channel 203 unrestricted. Thus, FIG. 4A represents an unaltered metering assembly 401. The channel is surrounded on one side by the female portion 209 and surrounded by the male portion 210 on the other side. In the figure, the flow restrictor 403 is a rectangular block.

FIG. 4B shows a D-shaped flow profile wherein the metering assembly 401 has been partially closed to resist flow, and accordingly decrease velocity. FIG. 4B depicts a shim 405 located between the female portion 209 and the flow restrictor 403. The shim 405 can comprise any material of virtually any shape so long as it is sized to fit within the die 200. The shims 405 can comprise flat sheets of material, plugs, washers, etc. of desired thickness. Because the shim 405 prevents the flow restrictor 403 from resting flush against the female portion 209 of the die, the flow restrictor 403 protrudes into the channel 203. This reduces the cross sectional area of the channel 203 through which product can flow. Thus, the cross sectional area of the channel 203 and accordingly the velocity of the extrudate is adjusted by varying the thickness of the shim 405 or by adding additional shims 405. Further, because the shim 405 is on the die side of the flow restrictor 403, many leaking issues which could otherwise arise are avoided. Looking to FIG. 4B, it can be appreciated that even if the product forces itself to the shim 405, then there is no place for the product to leak as the fastener device 402 is surrounded by the die. Thus, the instant invention circumvents the need to make the metering assembly 401 completely leak proof because the shims 405 and the metering assembly 401 are located within the die. This helps make the die less expensive to design and fabricate.

Note that while a D-shaped flow profile has been described the instant invention is not so limited. Any flow profile shape such as circular, oval, rectangular, or the like will suffice. Further, while much detail has been spent with regard to one embodiment, the current invention is not so limited. As discussed above, the flow restrictors 403 can comprise other materials such as washers or pegs, which can be protruded into a flow. As an example, a screw can be used as the flow restrictor 403 similar to the method just described. In such an embodiment, a screw is screwed into the female portion 209 of the die. A shim or other device is then inserted into the screw holes in the female 209 portion of the die, or the screw can be partially withdrawn. Thus, the screw cannot abut the female portion 209 and thus protrudes into the channel 203. Once the female 209 and the male 210 portions of the die are mated, the cross sectional area of the channel 203 is reduced and the flow velocity through the channel 203 is adjusted. Again, these examples are for illustrative purposes only and should not be deemed limiting.

Referring back to FIG. 2, once the product is split into channels 203 it is extruded through the extruder die 200. If the desired product is a co-extruded product, then while the outer product 205 is being extruded through the outer orifice 102 (of FIG. 1), inner product 204 is simultaneously and independently directed through the inner product tube 207 concentrically located within each channel 203 and then through an inner orifice 101 (of FIG. 1). FIG. 2 shows only two product tubes 207, but this was done primarily for clarity purposes. Typically, each channel 203 will have an associated inner product tube 207. In this embodiment the outer orifice 102 (of FIG. 1) is in communication with an associated channel 203 whereas the inner orifice 101 (of FIG. 1) is attached to a separate feed independent of the extruder.

As noted above, if so desired the extruder die 200 can extrude product which becomes the inner product whereas the product comprising the outer product is simultaneously and independently directed through an outer product tube. In such an embodiment (not shown) the channels through which product is extruded are concentrically located within an outer product tube. In this embodiment the inner orifice 101 (of FIG. 1) is in communication with an associated channel 203 whereas the outer orifice 102 (of FIG. 1) is attached to a separate feed independent of the extruder. Referring back to the figure, the size and location of the inner product tube 207 can be varied depending on the desired product. The inner product 204 can either be extruded product from another extruder or can be non-extruded product via a pump or other means. Regardless, the inner product 204 is used to fill the inside of the co-extruded product. It is often desirable and may be very desirable that each product exit the extruder at about the same velocity.

The extruded product then exits the orifice face and at a length of time downstream from the extruder die 200 is cut by co-acting nips 206. As FIG. 2 is a top view of a co-extruder, only the top nip 206 is illustrated. The coacting nips 206 grip, pull, and shear the extrudate into shorter pieces. In one embodiment each extrudate strand is directed to a single pair of coating nips 206. It can be appreciated that if each strand is directed to the same pair of nips 206, it is ideal if the strands comprise a uniform velocity as the nips 206 comprise a single velocity. As discussed above, if one strand has a much greater velocity than the other strands, then that strand will accumulate in front of the nips 206 as its velocity is greater than the velocity of the nips 206. Converse to this is the situation wherein one strand has a lower velocity than the other strands and the nips 206. Such a strand could be torn or ripped before it reaches the nips 206. Thus, the use of a single pair of nips 206 makes uniform velocity more desirable. Note that any other means known for cutting, shearing, or separating strands of extrudate can be utilized in place of co-acting nips 206. Thus, an apparatus has now been described which has a metering assembly 401 on each individual channel 203 in an extruder die that can be used to adjust and alter the flow rate to produce a plurality of extrudate strands of uniform velocity. The method of producing such a uniform flow rate will now be discussed.

The first step in producing a uniform velocity is selecting a die with individual channels which offers better control. Each channel shall also have an associated orifice. An extruder die with individual channels is in direct contrast with an extruder die which comprises a large distribution manifold. Such manifolds can result in increased residence time. An example of a large distribution manifold is found in a flat die. As discussed, increased residence times are often undesirable as it can result in product degradation including curing and gelling, as well as equipment malfunction due to plugging. Further, the use of a large distribution manifold limits the amount of control as there are no individual flow paths where metering assemblies can be applied. As the current invention utilizes individual channels, as opposed to one centralized manifold, each channel can be independently adjusted. Further, because the die utilized in this invention does not have a large distribution manifold, dough which requires very low residence time, on the order of about 2 seconds or less through the channels can be extruded using this method. In one embodiment, a residence time of about 30 seconds is desirable. Likewise this invention allows extrusion of dough at exit velocities as high as or higher than about 200 feet per minute. Residence time, temperature, pressure, and extrusion velocity may all be adjusted to accommodate different dough formulations. Thus, the current invention provides increased processing flexibility as it can process a wide variety of dough at a wide variety of processing conditions. This invention aims to produce distinct individual products which can optionally comprise a hollow center so as to be filled with an inner product. Such a product can be tubular in shape or comprise any cross-sectional shape capable of being produced by an extruder die. Further, this method provides a more cost effective and time efficient alternative compared to prior art methods.

After a die comprising individual channels 203 has been selected, a metering assembly 401 is installed in each channel 203. Such a metering assembly 401 is resistant to leaks and corrosion. The metering assembly 401 can comprise almost any food grade material. As discussed, the flow restrictor 403 of the metering assembly 401 can comprise a rectangular block, an annular plug, a threaded bolt, a peg, a screw, a washer, or the like. Further, each metering assembly 401 is capable of being individually adjusted.

Next, product is fed into the inlet 202 of the extruder die 200. The product is extruded to produce strands of extrudate. Strands of extrudate exiting from each individual orifice are then collected and weighed, measuring mass flow rate and relative exit velocity for each strand. The results can then be plotted on a graph such as that depicted in FIG. 3. This allows an operator to determine which orifice, or orifices, and corresponding metering assembly needs to be adjusted. For example, in FIG. 3 orifices 2 and 8 have a greater velocity than desired; therefore, the metering assembly 401 in orifice 2 and 8 need to be adjusted to decrease the flow through those respective channels. The exit velocity of each strand is adjusted by adjusting at least one metering assembly 401 associated with a channel. After the adjustments have been made, the product has again been extruded, the velocity and flow rate of each strand measured, then the steps are repeated in an iterative process to produce extrudate strands with more uniform velocity. After each iteration, each channel will produce a plurality of extrudate strands with more and more uniform velocity. However, just as each iteration alters the velocity of the adjusted orifice, it likewise adjusts the velocity of the non-adjusted orifices. Thus, subsequent iterations are typically necessary to produce a plurality of extrudate strands with uniform, or substantially uniform, velocity. In one embodiment three iterations were required to produce extrudate strands of substantially uniform velocity. If results were plotted after several iterations, referring back to FIG. 3, the velocity of orifices 2 and 8 will decrease, whereas, the velocity of orifice 7 and 10 will increase, resulting in a graph that is more encompassed by the solid line representing the mean flow rate. Thus, the velocity at each orifice will approximate the mean flow rate of all orifices. It should again be noted that this method of producing a plurality of extrudate strands with substantially uniform velocity can also be used on a co-extruder to produce a co-extruded product with an inner product and outer product, either one or both being extruded.

Once the extruded die 200 and metering assemblies 401 have been adjusted to result in a uniform product velocity for a specific dough formulation, then that extruder die 200 will produce a uniform product velocity for that specific dough formulation and any other dough formulation with a similar viscous flow behavior. If, for example, it is desired to extrude a different dough formulation with a much higher or lower viscosity than the dough formulation for which the adjustments were made, then a new round of iterative adjustments will likely need to be made, in which case it may be desirable to dedicate a separate die for production purposes.

In another embodiment, a computational algorithm can be developed which can estimate the change in channel restriction needed to obtain the desired change in velocity for a given orifice. An algorithm can be useful in that it can reduce the time required to find an optimum orifice adjustment. In other words, an algorithm improves the efficiency of the iterative repetitions described above. Whereas the above iterative process uses actual trials to determine the necessary adjustments, the algorithm instead predicts the adjustment shim thickness needed. For example, an algorithm calculates the area of each channel which it predicts will yield uniform flow. Then based on the area, the shim thickness is calculated. As an example, an initial trial run can be conducted and the results plotted on a graph similar to that of FIG. 3. The algorithm may then use the data collected and calculate the area of each channel, and in turn the shim thickness, which it predicts will result in uniform flow. The new shim thickness can then either be inserted into the extruder die, or alternatively the algorithm can then use the new shim thicknesses and predict the resultant flow which it then uses to calculate a new shim thickness. Thus, in one embodiment the algorithm is used iteratively to calculate an optimized shim thickness. By using such a computational algorithm, either iteratively or as a one-time calculation, the number of trial iterations can be reduced. However, there is a possibility of error in the estimated shim thickness which may arise from a number of things including, for example, a lack of precise knowledge of actual viscosity or other variables which affect the prediction of the algorithm. Those skilled in the art will appreciate that these errors within the algorithm may be reduced or offset with computational fluid dynamics (CFD) which can be used to model die flow and predict the necessary flow restrictions. Thus, the CFD may be used in conjunction with the method of the instant invention to provide a more accurate algorithm. However, even with CFD predictions, confirmation of the predictions is still required. Regardless, those skilled in the art will appreciate that the use of a computational algorithm can be used to make the iterative process more efficient. It should be noted that it is observed that simple iterative testing, as described above, can be faster and less costly than developing a CFD model and performing computation intensive modeling. This will be addressed in more detail below.

As described above, professional die designers may utilize CFD to design and simulate flow patterns to design a die with approximately balanced flow. However, this method is very expensive and relatively time consuming. The method of the instant invention can be substantially cheaper than the prior art methods for several reasons. First, the die used in the method of the instant invention can be designed relatively quickly because the die is not initially expected to produce flow with uniform velocity. Instead, the die is built with adaptability to allow the user to adjust the die to result in approximately uniform velocity. In one embodiment of the instant invention, the die took only three hours of design time, whereas a specialized die can take up to several days of a designer's time. Consequently, the design time is significantly faster and cheaper than using a professional die designer. Second, the die used in the instant invention can be fabricated cheaper than can a specialized die. Because the die of the instant invention is built to be adaptable, any errors in design or manufacture are corrected by the method of the invention. Accordingly, the die utilized in the instant invention can comprise less restrictive tolerances, and consequently is less extensive to manufacture than a specially designed die that is meant to instantly yield uniform flow. Taken further, because the die of the instant invention is adjustable it can be utilized with a variety of dough formulations. However, it is likely that a die specially designed to yield an approximately balanced flow for one dough formulation will be less effective with varied dough formulations. Finally, even after extensive design, the die may not function as intended, especially if the flow properties of the extrudate are difficult to measure accurately, as is often the case with biopolymer extrudates. Consequently there is significant risk that even after paying professional die designers to design and fabricate a specialized die, the die will not function as intended and will have to be re-designed and/or re-fabricated.

The aforementioned method results in a plurality of extrudate strands which comprises a more uniform flow of velocity. While the invention has been particularly shown and described with reference to a preferred embodiment, it will be understood by those skilled in the art that various changes in form and detail may be made therein without departing from the spirit and scope of the invention.

What is claimed is:

1. A method for yielding a plurality of extrudate strands of uniform velocity from a plurality of die orifices using an extruder system, said system comprising an extruder and a die, said die comprising individual channels with adjustable metering assemblies, said method comprising the steps of:
a) feeding product through said extruder die to produce strands of extrudate;
b) measuring the exit velocity of each said strand;
c) adjusting the exit velocity of each said strand by adjusting at least one metering assembly associated with a channel;
d) repeating steps b) and c) iteratively to produce a plurality of extrudate strands with substantially uniform velocity.

2. The method of claim 1 wherein said repealing of step d) is performed until a uniform velocity comprising a variance of less than about 10% of the mean velocity is achieved.

3. The method of claim 1 wherein said repeating of step d) is performed until a uniform velocity comprising a variance of less than about 5% of the mean velocity is achieved.

4. The method of claim 1 wherein said repeating of step d) is performed until a uniform velocity comprising a variance of less than about 1% of the mean velocity is achieved.

5. The method of claim 1 wherein said repeating of step d) produces extrudate strands with velocities greater than about 30 feet per minute.

6. The method of claim 1 wherein said feeding of step a) comprises a residence time of less than about 2 seconds in said channels.

7. The method of claim 1 wherein said adjusting of step c) is determined by a computational algorithm to improve the efficiency of the iterative repetitions of step d).

8. The method of claim 1 wherein the die is a co-extrusion die having at least one inner orifice and at least one outer orifice, and wherein further during said feeding step a) a first food product is fed through said inner orifice and a second food product is fed through said outer orifice.

9. The method of claim 8 wherein said feeding step a) comprises feeding a first food product through said inner orifice, wherein said first food product is a direct expanded product.

10. The method of claim 8 wherein said feeding step a) comprises feeding a first food product through said inner orifice, said first food product comprising a non-extruded product.

11. The method of claim 8 wherein said feeding step a) comprises feeding a first food product through said inner orifice, said first food product comprising an extruded product.

12. The method of claim 8 wherein said first food product and said second food product exit said extruder die at a substantially uniform velocity.

13. An extrudate food product made by the method of claim 1.

14. An extruder system comprising:
an extruder;
an extruder die, said die comprising:
a plurality of individual channels;
a plurality of die orifices, wherein each of said individual channels is in communication with one associated die orifice; and
a plurality of adjustable metering assemblies, wherein each, of said metering assemblies is in communication with one associated channel.

15. The extruder system of claim 14 wherein said extruder is a twin screw extruder.

16. The extruder system of claim 14 further comprising at least one pair of co-acting nips located at a distance downstream of said orifices.

17. The extruder system of claim 14 wherein said metering assembly comprises a rectangular block.

18. The extruder system of claim 14 wherein said metering assembly comprises an annular plug.

19. The extruder system of claim 14 wherein said metering assembly comprises a threaded bolt.

20. The extruder system of claim 14 wherein said metering assembly comprises a peg.

21. The extruder system of claim 14 wherein said metering assembly comprises a washer.

22. The extruder system of claim 14 further comprising a die face, wherein said orifices are radially placed along said die face.

23. The extruder system of claim 14 wherein each of said plurality of die orifices further comprises:
two concentric orifices, an inner orifice, and an outer orifice;
wherein each of said inner orifice is attached to a separate feed independent of said extruder;
and wherein each of said outer orifice is in communication with an associated channel.

24. The extruder system of claim 14 wherein each of said plurality of die orifices further comprises:
two concentric orifices, an inner orifice, and an outer orifice;
wherein each of said inner orifice is in communication with an associated channel;
and wherein each of said outer orifice is attached to a separate feed independent of said extruder.
